(19) United States
(12) Patent Application Publication
(10) Pub. No.: US 2026/0258221 A1
(43) Pub. Date: Sep. 3, 2026

(54) POLYOXMETHYLENE POLYMER INCORPORATING AN ALDEHYDE SCAVENGER

(71) Applicant: Colormatrix Holdings, Inc., Avon Lake, OH (US)

(72) Inventors: Christopher STARKIE, Knowsley (GB); Chen CHEN, Singapore (SG)

(21) Appl. No.: 18/878,761

(22) PCT Filed: Jun. 3, 2023
(86) PCT No.: PCT/IB2023/055730

§ 371 Date: Dec. 24, 2024

(30) Foreign Application Priority Data
Jun. 29, 2022 (GB) 2209527.7

(51) Int. Cl. C08K 5/20; C08J 3/205; C08K 5/134; C08K 5/315

(52) U.S. Cl. CPC C08K 5/20; C08J 3/2053; C08K 5/1345; C08K 5/315; C08J 2359/02

(57) ABSTRACT

A method of decreasing aldehyde content in a polyoxymethylene (POM) polymer comprises the step of contacting the POM polymer, or monomers, oligomers or pre-polymers involved in the preparation of said POM polymer, with a liquid formulation, wherein said liquid formulation comprises a liquid carrier and an aldehyde scavenger.

This invention relates to polymeric materials and particularly, although not exclusively, relates to polyoxymethylene (POM) in which aldehyde may undesirably be associated, for example by virtue of being produced during manufacture of the polymeric material, during downstream melt-processing of the polymeric materials and/or during use thereof.

Polyoxymethylene (POM) is also called acetal, polyacetal, or polyformaldehyde. It is a polymer with a linear ether structure (CH₂O-)n along its backbone. This linearity leads to a high crystallization degree that can be up to 80%, and density of 1.410-1.420 g/cm3. In some cases, POM may be filled, for example with glass fibres or carbon fibres.

POM finds increasing use in numerous applications, including electrical and electronics, consumer products, automotive and industrial machinery, medical devices, building and construction.

POM may be sold as a copolymer or a homopolymer. Homopolymer POM has the structure

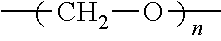

It consists essentially of the aforementioned repeat unit.

Copolymer POM includes the following repeat units:

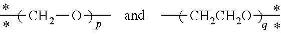

It consists essentially of the aforementioned repeat units.

Both homo and copolymer POM use methanol as the major basic raw material. For POM homopolymers, formaldehyde is synthesized through air oxidation of methanol, followed by formation of acetal resins by using ionic initiators. Replacement of the hydroxyl groups on polymer chain ends by ester groups stabilizes the resins in POM homopolymers. POM copolymers in general are produced using trioxane as the raw material (also produced starting from methanol). Around 2-3% epoxy-compounds are copolymerized with the trioxane to provide a stable POM copolymer. Chain end-capping may also be used. POM copolymer resin has greater stability but reduced crystallinity as a result of carbon-carbon bonded groups interspersed in its polymer chain. This polymer structure also imparts superior resistance to alkali, hot water, and other chemicals, as well as long life at elevated temperatures and more latitude in processing conditions. On the other hand, its tensile strength, rigidity, softening point and melting point are all lower than those found in the acetal homopolymer.

Polyoxymethylene (POM) is inherently unstable and prone to polymer degradation. POM degradation occurs via chain scission or end group decomposition. Common degradation products are formaldehyde, formic acid, cyclic acetals and oligomers. Melt processing of POM causes degradation of the polymer leading to the generation of formaldehyde. Formaldehyde emissions lead to challenges in workplace safety during polymer processing and restrict the use of the polymer in applications where air quality is critical such as automotive applications.

Formaldehyde generated by polymer degradation can oxidise to formic acid, contributing to the hydrolysis of the polymer chain. Aside from formaldehyde emissions, POM degradation leads to mold deposits, reduction in mechanical properties and discoloration.

POM resins may also be sensitive to acid hydrolysis by mineral acids. For example, low levels of chlorine in potable water can lead to environmental stress cracking. As such POM parts are stabilized to mitigate this degradation.

It is known to take steps to stabilise POM and reduce aldehyde emissions. For example, steps to effect stabilisation may be applied either during the final stages of POM production or during melt processing to form an article or masterbatch. Approaches to prevent POM degradation that have been developed include phenolic antioxidants to limit oxidative degradation, lubricants to reduce shear forces, acid scavengers to prevent formic acid hydrolysis, scavengers to react with free formaldehyde, use of end capping, light stabilisers and/or comonomers to improve stability.

Although various kinds of stabilization packages are commercially used, it is challenging to meet the material emissions targets such as VDA-275 target of 2 ppm for automotive applications alongside global emissions targets such as VDA-277 or VDA-278. Most treatments disclosed in the prior art that aim to control formaldehyde do not meet the VDA-275 target or, to do so, require uneconomic addition levels, impart discoloration and/or disadvantageously impact the properties of the POM.

It is an object of the present invention to address problems associated with aldehyde in POM.

It is an object of the present invention to address one or more of the above problems.

According to a first aspect of the invention, there is provided a method of decreasing aldehyde, for example formaldehyde, content in a polyoxymethylene (POM) polymer, the method comprising the step of contacting the POM polymer, or monomers, oligomers or pre-polymers involved in the preparation of said POM polymer, with a liquid formulation, wherein said liquid formulation comprises a liquid carrier and an aldehyde scavenger.

References herein to reducing aldehyde suitably primarily refer to formaldehyde which as described is a particular problem in the context of POM.

Preferably, the method comprises the step of contacting POM polymer with said liquid formulation.

A liquid formulation as described has unexpectedly been found to be advantageous over equivalent solid formulations, thereby allowing aldehyde scavengers to be delivered into POM at lower levels and/or to more readily reduce aldehyde emissions to levels which meet relevant materials emissions targets such as VDA-275.

References to a state of a material herein (e.g. a liquid) refer to the state at standard temperature and pressure (STP). Thus, said liquid formulation is suitably a liquid at STP; and said liquid carrier is suitably a liquid at STP.

Said POM suitably includes a —(CH₂O)— repeat unit (referred to as “repeat unit X”). It may also include a —(CH₂CH₂O)— repeat unit (referred as “repeat unit Y”). Preferably, in said POM, the sum of the mole % of repeat units X and Y is at least 80 mole %, preferably at least 90 mole %, more preferably at least 95 mole %, especially about 100 mole %.

In said POM, suitably the wt % of the POM polymer made up of repeat units X and Y is at least 80 wt %, preferably at least 90 wt %, more preferably at least 95 wt % and, especially, at least 98 wt %.

Said POM may be a homopolymer POM which suitably consists essentially of repeat units X or may be a copolymer POM which may comprise or preferably consist essentially of repeat units X and Y.

Said aldehyde scavenger may be any chemical which reduces aldehyde, for example, by reaction with aldehyde, in the method. Thus, the amount of aldehyde associated with the POM in the presence of an aldehyde scavenger is suitably less than in the absence of the scavenger.

In one embodiment, preferred aldehyde scavengers include both amine moieties and amide moieties. In one embodiment, preferred aldehyde scavengers include a substituted phenyl moiety. In one preferred embodiment, a said aldehyde scavenger may include an amine moiety (especially —NH₂), an amide moiety (especially —CONH₂) and a substituted phenyl moiety. In this case, it is preferred that both the amine moiety and the amide moiety are directly bonded to the phenyl moiety. Preferably, the amine moiety and amide moiety are bonded ortho to one another.

One class of aldehyde scavengers (referred to as scavengers AS1) may comprise a polyamide selected from the group consisting of low molecular weight partially aromatic polyamides having a number average molecular weight of less than 15,000, low molecular weight aliphatic polyamides having a number average molecular weight of less than 7,000, and combinations thereof. Preferred low molecular weight partially aromatic polyamides include: poly(m-xylylene adipamide), poly(hexamethylene isophthalamide), poly(hexamethylene adipamide-co-isophthalamide), poly(hexamethylene adipamide-co-terephthalamide), and poly(hexamethylene isophthalamide-co-terephthalamide). The most preferred low molecular weight partially aromatic polyamide is poly(m-xylylene adipamide) having a number average molecular weight of 4,000 to 7,000 and an inherent viscosity of 0.3 to 0.6 dL/g. Preferred low molecular weight aliphatic polyamides include poly(hexamethylene adipamide) and poly(caprolactam). The most preferred low molecular weight aliphatic polyamide is poly(hexamethylene adipamide) having a number average molecular weight of 3,000 to 6,000 and an inherent viscosity of 0.4 to 0.9 dL/g.

Another class of aldehyde scavengers (referred to as scavengers AS2) may include at least two component molecular fragments, each component molecular fragment comprising at least two hydrogen substituted heteroatoms bonded to carbons of the respective component molecular fragment. The component molecular fragments of the organic additive compound are each reactive with aldehyde in a polyester to form water and a resulting organic molecular fragment comprising an unbridged five or six member ring including the at least two heteroatoms. Preferably, the organic additive compounds have at least twice the molecular weight of the component molecular fragments alone. The heteroatoms present in each molecular fragment capable of reacting with aldehyde include oxygen (O), nitrogen (N), and sulfur (S). The heteroatoms of the component molecular fragments suitably have at least one bond to an active hydrogen (H), and in the course of condensing with aldehyde should split off water. Preferred functional groups containing these heteroatoms include amine (NH2 and NHR), hydroxyl (OH), carboxyl (CO2H), amide (CONH2 and CONHR), sulfonamide (SO2NH2), and thiol (SH). It is necessary for these functional groups to be sterically arranged so that on condensation with aldehyde an unbridged 5 or 6 membered ring can be formed. It is preferred that the structural arrangement allows the formation of a six membered ring. It is especially preferred that heteroatoms of the organic additive are attached to a preformed ring or rings. It is most preferred that the preformed ring(s) are aromatic so that the unbridged 5 or 6-member ring of the resulting organic compound is bonded to the aromatic ring. Suitable organic additive compounds may be substantially thermally stable at the temperatures required for melt-processing the polyester. It is also preferred that the functional groups present on the organic additive are relatively unreactive towards the ester linkages present in polyesters. Examples of preferred scavengers include 1,2-bis(2-aminobenzamidoyl)ethane; 1,2-bis(2-aminobenzamidoyl)propane; 1,3-bis(2-aminobenzamidoyl)propane; 1,3-bis(2-aminobenzamidoyl)pentane; 1,5-bis(2-aminobenzamidoyl)hexane; 1,6-bis(2-aminobenzamidoyl)hexane; and 1,2-bis(2-aminobenzamidoyl)cyclohexane. More preferred are scavengers where the component molecular fragments are derived from anthranilamide.

Another class of aldehyde scavengers (referred to as scavengers AS3) suitable for use in the present invention include anthranilamide, 1,8-diaminonaphalene, allantoin, 3,4-diaminobenzoic acid, malonamide, salicylanilide, uracil, 6-amino-1,3-dimethyluracil (DMU), 6-aminoisocytosine, 6-aminouracil, 6-amino-1-methyluracil, α-tocopherol, triglycerin, trimethylolpropane, dipentaerythritol, tripentaerythritol, D-mannitol, D-sorbitol, and xylitol. From the aforementioned group, anthranilamide, 1,8-diaminonaphalene, allantoin, 3,4-diaminobenzoic acid, malonamide, salicylanilide, 6-amino-1,3-dimethyluracil (DMU), 6-aminoisocytosine, 6-aminouracil, 6-amino-1-methyluracil are preferred.

Another class of aldehyde scavengers (referred to as scavengers AS4) may comprise a hydroxylic compound selected from aliphatic hydroxylic compounds containing at least two hydroxyl groups, aliphatic-cycloaliphatic compounds containing at least two hydroxyl groups, and cycloaliphatic hydoroxylic compounds containing at least two hydroxyl groups.

The hydroxylic compounds preferably contain from 3 to about 8 hydroxy groups. They may contain one or more substituents, such as ether, carboxylic acid, carboxylic acid amide or carboxylic acid ester groups.

Preferred hydroxylic compounds include those having a pair of hydroxyl groups which are attached to respective carbon atoms which are separated one from another by at least one atom. Especially preferred hydroxylic compounds are those in which a pair of hydroxyl groups are attached to respective carbon atoms which are separated one from another by a single carbon atom.

As examples of suitable hydroxylic compounds there can be mentioned diols such as ethylene glycol, propane-1,2-diol, propane-1,3-diol, butane-1,4-diol, pentane-1,5-diol, hexane-1,2-diol, 2-methylpentane-2,4-diol, 2,5-dimethyl-hexane-2,5-diol, cyclohexane-1,2-diol, cyclohexane-1,1-dimethanol, diethylene glycol, triethylene glycol, and polyethylene glycols having, for example, a molecular weight from about 800 to about 2000, such as Carbowax™ 1000 which has a molecular weight of about 950 to about 1050 and contains from about 20 to about 24 ethyleneoxy groups per molecule; triols, such as glycerol, trimethylolpropane, 2,3-di-(2′-hydroxyethyl)-cyclohexan-1-ol, hexane-1,2,6-triol, 1,1,1-tris-(hydroxymethyl) ethane, 3-(2′-hydroxyethoxy)-propane- 1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methylphenyl)-propane, 1,1,4-tris-(dihydroxyphenyl)-butane, 1,1,5-tris-(hydroxyphenyl)-3-methylpentane, trimethylolpropane ethoxylates of the formula:

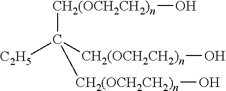

in which n is an integer, or trimethylolpropane propoxylates of the formula:

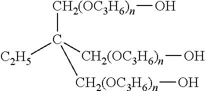

in which n is an integer, for example a trimethylolpropane propoxylate which has a molecular weight of about 1000; polyols such as pentaerythritol, dipentaerythritol, and tripentaerythritol; and saccharides, such as cyclodextrin, D-mannose, glucose, galactose, sucrose, fructose, xylose, arabinose, D-mannitol, D-sorbitol, D- or L-arabitol, xylitol, iditol, talitol, allitol, altritol, guilitol, erythritol, threitol, and D-gulonic-Y-lactone; and the like. Mixtures of two or more such compounds can be used. Especially preferred are aliphatic hydroxylic compounds which contain from 3 to about 8 hydroxy groups.

Another class of aldehyde scavengers (referred to as scavengers AS5), comprise a compound (A) which includes:
(I) a first fragment which comprises a moiety

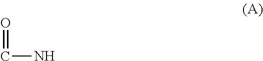

and a moiety

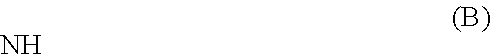

wherein the carbon atom of moiety (A) and the nitrogen atom of moiety (B) are separated by at least one and not more than two atoms;
(II) a second fragment which comprises a moiety

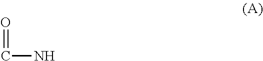

and a moiety

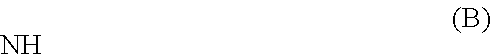

wherein the carbon atom of moiety (A) and the nitrogen atom of moiety (B) are separated by at least one and not more than two atoms; and
(III) a third fragment which comprises a moiety

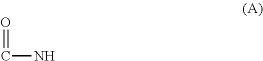

and a moiety

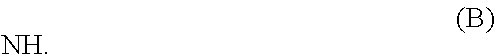

Said first fragment may comprise a moiety:

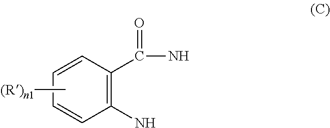

wherein R′ represents a substituent and n1 is 0 to 4, for example 0 to 1 and, preferably, n1 is 0. R′ may be an optionally-substituted alkyl group, for example an optionally-substituted C₁₋₂₀, for example C₁₋₁₀ alkyl group. R′ may be arranged to improve the compatibility of compound (A) in the polymeric material with which it is contacted in the method, for example by virtue of R′ including relevant functional groups to improve compatibility. Alternatively and/or additionally, R′ may be arranged to increase the mass of the compound (A).

Moiety (B) in said first fragment is preferably NH₂ and/or the NH moiety bonded to the benzene moiety is preferably NH2.

The moiety (C) is suitably capable of reacting with aldehyde in a condensation reaction to produce a moiety

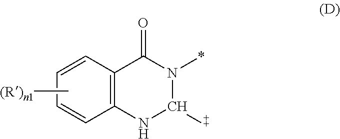

wherein the bond with a * represents the attachment of moiety (D) to another part of compound (A) and the bond with a ‡ represents part of the aldehyde which reacts with moiety (C). When the level of aldehyde is reduced in the method, compound (D) may be of formula

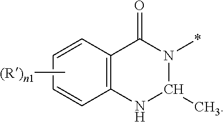

Thus, by virtue of the reaction, the aldehyde is scavenged and its residue becomes covalently bonded into the compound (A).

Said second fragment may comprise a moiety:

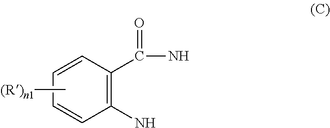

wherein R′ represents a substituent and n1 is 0 to 4, for example 0 to 1 and, preferably, n1 is 0. R′ may be a optionally-substituted alkyl group, for example an optionally-substituted C₁₋₂₀, for example C₁₋₁₀ alkyl group. R′ may be arranged to improve the compatibility of compound (A) in the polymeric material with which it is contacted in the method, for example by virtue of R′ including relevant functional groups to improve compatibility. Alternatively and/or additionally, R′ may be arranged to increase the mass of the compound (A).

Moiety (B) of said second fragment is preferably NH₂ and/or the NH moiety bonded to the benzene moiety is preferably NH₂.

Said third fragment may comprise a moiety:

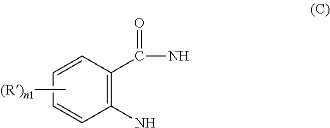

wherein R′ represents a substituent and n1 is 0 to 4, for example 0 to 1 and, preferably, n1 is 0. R′ may be a optionally-substituted alkyl group, for example an optionally-substituted C₁₋₂₀, for example C₁₋₁₀ alkyl group. R′ may be arranged to improve the compatibility of compound (A) in the polymeric material with which it is contacted in the method, for example by virtue of R′ including relevant functional groups to improve compatibility. Alternatively and/or additionally, R′ may be arranged to increase the mass of the compound (A). Moiety (B) of said third fragment is preferably NH₂ and/or the NH moiety bonded to the benzene moiety is preferably NH₂.

Said first fragment, said second fragment and said third fragment are preferably bonded to a main fragment of compound (A), suitably via the nitrogen atoms of moiety CO·NH of respective moieties (A) of said first fragment, said second fragment and said third fragment. In a preferred embodiment, said compound (A) consists essentially of said first fragment, said second fragment, said third fragment and said main fragment.

Said main fragment may include only carbon, hydrogen and, optionally, nitrogen atoms.

Preferably, said main fragment includes substantially no primary amine moieties (—NH₂) except, optionally, primary amine moieties which are separated from a carbonyl moiety (C═O) by at least one and not more than two atoms.

Optionally, said main fragment may include one or more secondary or tertiary amine moieties. Except for any aromatic carbon atoms and carbonyl moieties, said main fragment preferably does not include any unsaturated carbon atoms. Said main fragment preferably does not include any alkenyl or alkynyl groups.

Preferred scavengers AS5 includes a structure detailed below:

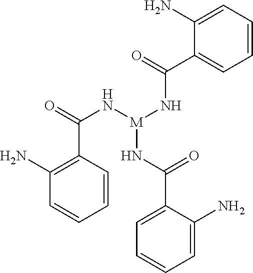

wherein M represents a Main Fragment which includes atoms selected from carbon, hydrogen, oxygen and nitrogen atoms. More preferably, M represents a Main Fragment which includes atoms selected from carbon, hydrogen and nitrogen atoms. It may include a saturated hydrocarbon moiety which may incorporate a nitrogen atom, for example a secondary amine moiety.

Another class of aldehyde scavengers (referred to as scavengers AS6), comprise a compound XX which includes at least three moieties of formula

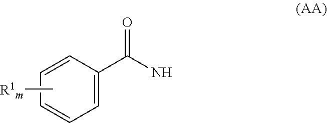

wherein each moiety (AA) includes an amine moiety (—NH₂) bonded ortho or meta to the amide moiety (—CONH);
wherein each R¹ independently represents a substituent and m is an integer from 0 to 4; and
wherein the three moieties (AA) are bonded, via their respective amide nitrogen atoms, to respective carbon atoms of a Main Fragment, wherein the Main Fragment includes carbon and hydrogen atoms only and is saturated.

One or each R¹ may be selected from a halogen atom, or an optionally-substituted hydrocarbon, alkoxy, amine, amide, phenol or carboxylic acid, group. An optionally-substituted hydrocarbon may be substituted by one or more halogen atoms or by alkoxy, amine, amide, phenol or carboxylic acid, groups. An optionally-substituted hydrocarbon is preferably un-substituted.

One or each R¹ may be an optionally-substituted, preferably an unsubstituted, alkyl group, for example an optionally-substituted, preferably an unsubstituted, C₁₋₂₀, for example C₁₋₁₀ alkyl group. R¹ may be arranged to improve the compatibility of compound XX in the polymeric material in which it may be incorporated, for example by virtue of R¹ including relevant functional groups to improve compatibility.

One or each m may be 0 or 1. Preferably, each m=0. That is, other than the amine and amide moieties, each moiety (A) is unsubstituted.

Preferably, in compound XX, at least one moiety (AA) includes an amine moiety (—NH₂) bonded ortho to the amide moiety (—CONH). Preferably in each moiety (AA) in compound XX, the amine moiety is bonded ortho to the amide moiety. Preferably, in this case, m=0.

Preferably, said Main Fragment does not include any cyclic or aromatic moiety. Preferably said Main Fragment comprises a linear or branched chain.

Said Main Fragment may include 3 to 20 carbon atoms. Preferably, it includes 5 to 15 carbon atoms, more preferably 7 to 12 carbon atoms and, especially, 8 to 10 carbon atoms. When the number of carbon atoms is n, the number of hydrogen atoms may be equal to 2n-1. Preferably, said Main Fragment includes 5 to 39 hydrogen atoms. Preferably, it includes 9 to 29 hydrogen atoms, more preferably 13 to 23 hydrogen atoms and, especially, 15 to 19 hydrogen atoms.

In a preferred embodiment, said Main Fragment is a C₉H₁₇ moiety.

Said Main Fragment may include a linear chain which includes 6 to 14 carbon atoms, preferably 6 to 10 carbon atoms. The linear chain may include a branch point to which a chain which includes 1 to 4 carbon atoms is attached.

Said Main Fragment may be of general formula

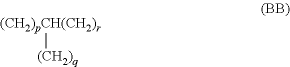

wherein p, q and r are integers, suitably in the range 1 to 10, preferably 1 to 5. Preferably, p is in the range 2 to 4, q is in the range 1 to 3 and r is in the range 2 to 6.

Preferably, the sum of integers p, q and r is at least 4, preferably at least 6, more preferably at least 7. Said sum may be less than 20, preferably less than 15, more preferably less than 10.

In compound XX, preferably the nitrogen atoms of the amide moieties (—CONH) are spaced apart by at least 2, preferably at least 4, carbon atoms; and suitably by no more than 10, for example no more than 7 carbon atoms.

Said compound XX may be of formula

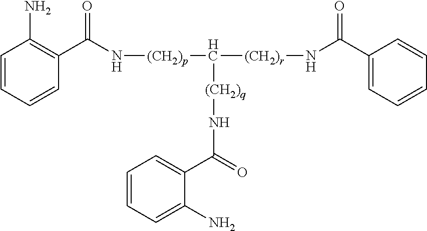

wherein p, q and r are as described above.

Said compound XX is preferably

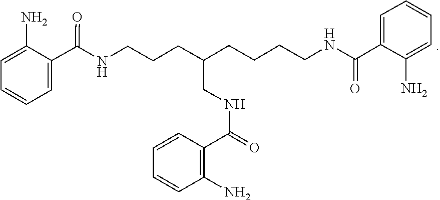 [SMILES: Nc1ccccc1C(=O)NCCCCC(CCCNC(=O)c1ccccc1N)CNC(=O)c1ccccc1N]

In an embodiment, said aldehyde scavenger may be selected from: Polyethyleneimine or other ethylene amines; hydrazides; carbodiimides; aminotriazines eg melamine; guanamine related compounds; triethanolamines; acrylamide copolymers; urea and organic derivatives.

Another class of aldehyde scavengers (referred to as scavengers AS7) may be of general formula

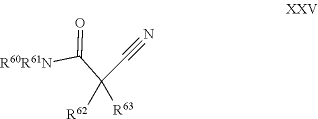

wherein R⁶⁰ and R⁶¹ independently represent a hydrogen atom or an optionally-substituted, preferably unsubstituted, alkyl, cycloalkyl or aromatic group; and wherein R⁶² and R⁶³ independently represent a hydrogen atom or an optionally-substituted, preferably unsubstituted, alkyl, cycloalkyl or aromatic group.

In a preferred embodiment of said compound of formula XXV, R⁶⁰ and R⁶¹ independently represent a hydrogen atom or an unsubstituted alkyl or cycloalkyl group and R⁶² independently represent a hydrogen atom or an unsubstituted alkyl or cycloalkyl group. In an especially preferred embodiment, R⁶⁰, R⁶¹, R⁶² and R⁶³ each represent hydrogen atoms.

Preferred aldehyde scavengers include at least one amide moiety. Preferably, the carbon atom of the at least one amide moiety is separated form a nitrogen atom by at least two other atoms which are preferably carbon atoms. At least one of said two carbon atoms is preferably unsaturated. Such preferred aldehyde scavengers may include a moiety

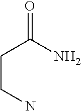

wherein the carbon atoms may be unsaturated, for example being part of a phenyl ring; or include a moiety

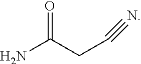

Especially preferred aldehyde, for example formaldehyde, scavengers are selected from anthranilamide, compound XX and cyanoacetamide.

A reference herein to “ppm” refers to “parts per million” by weight.

Said formulation may include at least 30 wt %, preferably at least 40 wt %, more preferably at least 50 wt % liquid carrier. It may include less than 90 wt %, preferably less than 80 wt %, liquid carrier. Said liquid formulation may comprise 50 to 90 wt % (for example 50 to 80 wt %) of liquid carrier and 10 to 50 wt % (for example 20 to 50 wt %) of said aldehyde scavenger. Said liquid carrier is preferably a liquid at 25° C. and atmospheric pressure. A liquid carrier is suitably such that it has good solubility in the POM into which it is to be added. It may comprise an oil (e.g. vegetable or mineral oil) or a glycol. Typical carriers include hydrocarbons, hydrocarbon mixtures, alcohols, esters, polyethers and mixtures of two or more thereof. A POM-compatible organic liquid carrier may be an oil-based vehicle. Examples of such vehicles are the materials sold as Clearslip™ 2, Clearslip™ 3 & Process Aid-1 by ColorMatrix Europe Ltd, of Units 9-11 Unity Grove, Knowsley Business Park, Merseyside, L34 9GT.

Said formulation may include 0 to 10 wt % of other additives. It may include 0 to 5 wt %, for example 0 to 3 wt %, of dispersant.

It is found that inclusion of an anti-oxidant can act synergistically in the liquid formulation to improve aldehyde scavenging performance. Said formulation may include 0 to 10 wt % of one of more anti-oxidants. The sum of the wt % of anti-oxidants in the formulation may be in the range 0 to 10 wt %, preferably in the range 0.5 to 10 wt %, or 0.5 to 7.0 wt %. Said liquid formulation preferably includes at least 1.0 wt % of an anti-oxidant.

Said formulation may optionally include a phosphorus-containing antioxidant (e.g., a phosphite-series compound such as triphenyl phosphite, a triphenyl phosphate-series compound such as tris(2,4-di-t-butylphenyl) phosphate, a diphosphonite-series compound, and a metal salt of hypophosphorous acid).

Said anti-oxidant may comprise a sterically-hindered phenol compound. Said anti-oxidant may include a moiety.

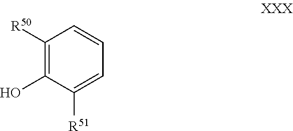

wherein R⁵⁰ and R⁵¹ independently include at least four atoms which are preferably selected from C, H, O and N atoms; and more preferably, are selected from C and H atoms. R⁵⁰ and R⁵¹ are preferably saturated. R⁵⁰ may represent a tertiary alkyl moiety, for example a tertiary alkyl moiety which includes at least 4 carbon atoms. R⁵⁰ preferably represents a t-butyl moiety. R⁵¹ may represent a C₁₋₄ alkyl moiety, especially a methyl group.

Said anti-oxidant may include at least two moieties XXX.

Said anti-oxidant may include one or more oxyalkylene moieties, for example oxyethylene moieties.

Said anti-oxidant may include one or more ester moieties.

Said anti-oxidant preferably includes C, H and O atoms only.

Said anti-oxidant may be of formula

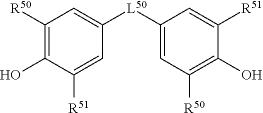

wherein L⁵⁰ is a linking moiety which suitably includes said oxyalkylene moieties and one or more ester moieties. Said anti-oxidant may be as follows:

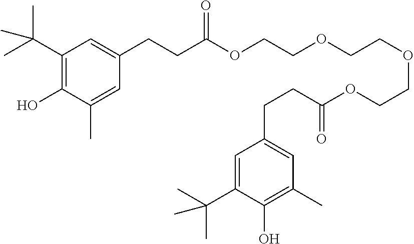 [SMILES: Cc1cc(CCC(=O)OCCOCCOCCOC(=O)CCc2cc(C)c(O)c(C(C)(C)C)c2)cc(C(C)(C)C)c1O]

Said method preferably decreases aldehyde content in the POM polymer so the POM polymer includes 2 ppm or less of aldehyde when assessed according to VDA-275.

According to a second aspect of the invention, there is provided a polyoxymethylene (POM) polymer, having a reduced level of aldehyde, said POM polymer incorporating an aldehyde scavenger according to the first aspect or a product of a reaction between an aldehyde scavenger according to the first aspect and aldehyde.

Said POM polymer preferably includes 2 ppm or less of aldehyde when assessed according to VDA-275.

Said POM polymer preferably includes residual carrier as described according to the first aspect.

Said POM polymer preferably includes anti-oxidant as described according to the first aspect.

Said POM polymer may be in pellet form.

A liquid formulation as described may be used in the manufacture of parts or in the manufacture of pellets, for example masterbatch pellets, which may be used in subsequent manufacture of parts. Thus, according to a third aspect of the invention, there is provided a method of making an article, for example a shaped article, or pellets from a polyoxymethylene (POM) polymer, the method comprising
(a) selecting a liquid formulation comprises a liquid carrier and an aldehyde scavenger as described in the first aspect and/or second aspects;
(b) contacting the POM polymer with said liquid formulation; and
(c) forming said POM polymer into an article, for example a shaped article or into pellets.

Said article or pellets preferably includes 2 ppm or less of aldehyde when assessed according to VDA-275.

Preferably, in step (c), the POM polymer is suitably melt-processed to define said article or pellets.

Said article or pellets may be defined by any process known in the art. For example, said process may comprise injection molding, blow molding, thermoforming or extrusion.

Said article or pellets may include one or more colourants and may include 5-500 ppm of a colourant, for example when an article is made. The aforementioned ppm is suitably based on the amount of said POM polymer. A said colourant described herein may be a dye or pigment.

When pellets are made, the pellets may include up to 60 wt % of colourant, for example titanium dioxide. Such pellets may define a masterbatch which suitably includes 5 to 35 wt % fillers, for example colourants, suitably as described.

Preferably, in said shaped article, the sum of the wt % of one or more POM polymer(s), and the aldehyde scavenger is at least 90 wt %, at least 95 wt % or at least 98 wt %.

According to a fourth aspect of the invention, there is provided an article or pellet having a reduced level of aldehyde, made as described in the fourth aspect and/or comprising (POM) polymer and a said aldehyde scavenger as described.

Said article preferably includes 2 ppm or less of aldehyde when assessed according to VDA-275.

Any aspect of any invention described herein may be combined with any other aspect of any invention described herein mutatis mutandis.

Specific embodiments of the invention will now be described by way of example.

The following materials are referred to hereinafter:
Anthranilamide—a commercially-available product obtained from Sigma Aldrich;
2-cyanoacetamide—a commercially-available product obtained from Fisher Scientific;
Irganox 1010—commercially-available pentaerythritol tetrakis(3,5-di-tert-butyl-4-hydroxyhydrocinnamate) obtained from Sigma Aldrich;
Carrier A—refers to Clearslip™ 2 available from ColorMatrix. Carrier A was selected to have good solubility in the POM co-polymer used.
Co-polymer POM—refers to Ultraform S2320 POM co-polymer obtained from BASF;

### Assessment 1—General Procedure for Determining Formaldehyde Content of Plaques

The formaldehyde content of samples is determined on injection moulded plaques (40×100×3 mm (W×L×D)). The level of formaldehyde is determined using a Markes Micro-Chamber/Thermal Extractor™ (p-CTE™). The device is a versatile and compact unit with up to four small cylindrical chambers that enables the sampling of chemicals released from products or materials. Released volatile and semi-volatile organic compounds (VOCs and SVOCs) are collected in cartridges containing 2,4-dinitrophenylhydrazine for analysis by HPLC in accordance with ISO 16000-3. Formaldehyde reductions are calculated on the basis of percentage reduction seen in the formaldehyde levels of a part with additives, compared to a reference part that did not contain the additive. The assessment described has been shown to be comparable to VDA-275 which is an automotive standard formaldehyde test.

### Assessment 2—Procedure for Measuring Optical Properties

Plaques (sizes 95×165×3 mm (W×L×D)) made in a manner similar to that described below and relevant controls were made and optical properties (i.e. L*, a* and b*) were assessed using a Minolta CM-3700d spectrophotometer in transmission mode fitted with a D65/10° light source.

| Polymer | Ultraform S2320 |
|---|---|
| Machine name | Engel ES 330/70 HL |
| Zone 3 temp. (° C.) | 190 |
| Zone 2 temp. (° C.) | 190 |
| Zone 1 temp. (° C.) | 190 |
| Nozzle temp. (° C.) | 200 |
| Mold temp. (° C.) | 50 |

### Assessment 3—Oxidative Induction Time Testing

Oxidation induction time (OIT) tests were conducted using a heat-flux differential scanning calorimetry (DSC) to analyse the thermal stability of POM samples. Samples of about 5-6 mg were heated from room temperature to 230° C. under a flow of nitrogen gas (50 ml/min) and held for 5 minutes. The gas flow was switched to oxygen (50 ml/min) and held constant to investigate the induction time. The peak maximum and not the onset temperature of the OIT response will be taken as the OIT results as observation shows that it is difficult to determine a well-defined onset temperature, as discussed in V. Archodoulaki, S. Luftl and S. Seidler, “Oxidation induction time studies on the thermal degradation behaviour of polyoxymethylene”, Polymer Testing, vol. 25, no. 1, pp. 83-90, 2006.

### EXAMPLE 1—PREPARATION OF ACETALDEHYDE SCAVENGER N,N′-(2-(4-(2-AMINOBENZAMIDO)BUTYL)PENTANE-1,5-DIYL)BIS(2-AMINOBENZAMIDE) (REFERRED TO AS COMPOUND X)

Compound X has the following structure.

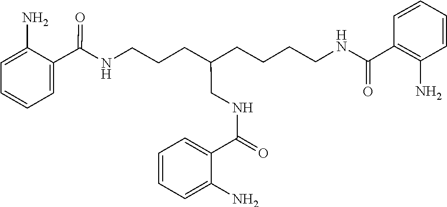 [SMILES: Nc1ccccc1C(=O)NCCCCC(CCCNC(=O)c1ccccc1N)CNC(=O)c1ccccc1N]

2H-benzo[d][1,3]oxazine-2,4(1H)-dione (98.84 g, 3.5 Eq, 605.9 mmol) was dissolved in dimethylformamide (500 ml) at room temperature. To the reaction mixture was drop-wise added a solution of 4-(aminomethyl)octane-1,8-diamine (30.00 g, 1 Eq, 173.1 mmol) in dimethylformamide (250 ml). The reaction mixture was stirred at room temperature overnight until full conversion was evidenced by LC-MS. The dimethylformamide was removed under reduced pressure yielding a dark brown oil. To this was added water (1 l), ammonium hydroxide (25%, 50 ml) and the product extracted with dichloromethane. The dichloromethane was removed under reduced pressure and the product recrystallized in a mixture of methanol and acetonitrile. The solids were collected by filtration and dried to yield N,N′-(2-(4-(2-aminobenzamido)butyl)pentane-1,5-diyl)bis(2-aminobenzamide) (51.0 g, 55.5% yield). The structure of the compound was confirmed by NMR and LC-MS and the melting point was 160° C.

### EXAMPLE 2—PREPARATION OF N,N′-(HEXANE-1,6-DIYL)BIS(2-AMINOBENZAMIDE) (REFERRED TO AS COMPOUND Y)

To a stirred mixture of 2H-benzo[d][1,3]oxazine-2,4(1H)-dione (175 g, 2.5 Eq, 1.08 mol) in DMSO (1000 ml), was slowly added solution of hexane-1,6-diamine (50.0 g, 1 Eq, 430 mmol) in DMSO (150 ml). The reaction mixture was stirred overnight followed by the addition of water. The resultant solids were collected by filtration and dissolved in hot EtOAc with the addition of 2N HCl. The solids were removed by filtration and dissolved in EtoAC and 25% ammonium hydroxide solution. The mother liquor was washed with EtOAc. The organic extracts were collected and dried with anhydrous sodium sulfate. The solvent was removed to yield a brown solid. The crude product was filtered and washed with EtOAc and DCM. The solids were collected and dried to yield N,N′-(hexane-1,6-diyl)bis(2-aminobenzamide) (102.2 g, 67.0%), Example 3—General procedure for preparing solid formulations Solid Masterbatch formulations were prepared by the blending of the required amounts of base polymer, formaldehyde reducing agent and antioxidant stabilizer in a twin screw extruder. Pellets were cut using a strand cutter. The materials were prepared using a Labtech LTE444-16 twin-screw extruder using the following conditions

| | |
|---|---|
| Screw | 300 |
| speed | |
| (rpm) | |
| Feed rate | 3 |
| (kg/h) | |
| Screw | 44:1 |
| ratio | |
| Zone 1 | 80 |
| (° C.) | |
| Zone 2 | 175 |
| (° C.) | |
| Zone 3 | 190 |
| (° C.) | |
| Zone 4 | 200 |
| (° C.) | |
| Zone 5 | 200 |
| (° C.) | |
| Zone 6 | 200 |
| (° C.) | |
| Zone 7 | 200 |
| (° C.) | |
| Zone 8 | 185 |
| (° C.) | |
| Zone 9 | 180 |
| (° C.) | |
| Zone 10 | 190 |
| (° C.) | |

### EXAMPLE 4—GENERAL PROCEDURE FOR PREPARING LIQUID FORMULATIONS

Liquid formulation were prepared by combining the liquid Carrier A and dispersant in a liquid mixing vessel. To this was added the aldehyde scavenging agent and antioxidant. Optionally, the formulation may be milled to yield desirable particle sizes. Rheology modifiers may be optionally added. Dispersants are also optional. The formulation was mixed under vacuum to remove any residual air.

Liquid and solid formulations comprising aldehyde scavengers were prepared and compared when added to Co-polymer POM, as described in the following examples.

### EXAMPLE 5—PREPARATION OF SOLID FORMULATION OF 2-CYANOACETAMIDE

Following the procedure described generally in Example 3, a solid formulation having the following composition was prepared:

| | Aldehyde | Amount | | | | |
|---|---|---|---|---|---|---|
| | scavenger | of AS | | Amount | | Amount |
| Formulation | (AS) | component | Anti- | of anti- | Solid | of |
| No. | component | (wt %) | oxidant | oxidant | Carrier | Carrier |
| I | 2-cyanoacetamide | 12 | Irganox | 4 | CoPolymer | 84 |
| | | | 1010 | | POM | |

### EXAMPLE 6—PREPARATION OF LIQUID FORMULATIONS OF 2-CYANOACETAMIDE, COMPOUND X AND ANTHRANILAMIDE

Following the procedure described in Example 4, liquid formulations having the following compositions were prepared. Note that the carrier was Carrier A and the anti-oxidant was Irganox 1010 in each case.

| | | Amount of | | | Amount |
|---|---|---|---|---|---|
| For- | | AS | anti- | | of fumed |
| mulation | | Component | oxidant | Carrier | silica |
| No. | AS Component | (wt %) | (wt %) | (wt %) | (wt %) |
| II | Compound X (ie | 20 | 3.33 | 76.67 | 0 |
| | the compound | | | | |
| | of Example 1) | | | | |
| III | Anthranilamide | 32.7 | 5.56 | 59.74 | 2 |
| IV | 2- | 35 | 5.83 | 58.17 | 1 |
| | cyanoacetamide | | | | |

### EXAMPLES 8 TO 11—ASSESSMENT OF SOLID AND LIQUID FORMULATIONS

The solid or liquid formulations (I to IV) described in Examples 5 and 6, were dosed into CoPolymer POM at the dose rates detailed in the table below and plaques of dimensions 40 mm×100 mm×20 mm made. The formaldehyde emissions were assessed as described in Assessment 1 and the L*, a* (D65), b* (D65) were assessed as described in Assessment 2.

Results are provided in the table below:

| | | Dosage % | Formaldehyde | | | |
|---|---|---|---|---|---|---|
| | | (based on | emissions | | | |
| Example | Formulation | POM taken | ISO: 16003 | L* | a* | b* |
| No. | used | to be 100%) | (ppm) | (65) | (D65) | (D65) |
| 8 | I | 2.00 | 0.65 | 90.05 | −4.95 | 38.14 |
| 9 | II | 1.18 | 2.04 | 90.72 | 0.77 | 6.17 |
| 10 | III | 0.91 | 3.09 | 93.19 | 0.07. | 2.12 |
| 11 | IV | 0.55 | 0.30 | 93.92 | −4.36 | 15.81 |
| Control | — | — | 4.30 | — | | |

The control refers to CoPolymer POM with no additives.

It should be noted from the results that Examples 8 and 11 include the same aldehyde scavenger delivered at the same concentration to the polymer. The liquid dispersion (Formulation IV) is found to provide greater efficacy, at a lower addition level, and significantly reduced discolouration.

### EXAMPLE 12—PREPARATION OF SOLID AND LIQUID FORMULATIONS COMPRISING ANTHRANILAMIDE

Following the procedures described in Examples 5 and 6, solid and liquid formulations comprising anthranilamide were prepared having the compositions detailed in the table below. In the following, the aldehyde scavenger (AS) component was anthranilamide, the anti-oxidant was Irganox 1010, the liquid carrier for Formulation No. VI was Carrier A and the solid carrier for Formulation No. V was Co-polymer POM.

| | Amount of | | | |
|---|---|---|---|---|
| | AS | anti- | | Amount of |
| Formulation | Component | oxidant | Carrier | fumed |
| No. | (wt %) | (wt %) | (wt %) | silica (wt %) |
| VI | 32.7 | 5.56 | 59.74 | 2 |
| V | 12 | 2 | 86 | 0 |

### EXAMPLE 13 TO 14—ASSESSMENT OF SOLID AND LIQUID FORMULATIONS COMPRISING ANTHRANILAMIDE

Solid and liquid formulations V and VI were added to Ultraform S2320 POM co-polymer and plaques produced by injection moulding at the let-down-ratios (LDRs) as described in the table below. The formaldehyde emissions were assessed as described in Assessment 1 and the L*, a* (D65), b* (D65) were assessed as described in Assessment 2.

| | | | | Formaldehyde | | | |
|---|---|---|---|---|---|---|---|
| | | | wt % | emissions | | | |
| Example | Formulation | LDR | anthranilamide | ISO: 16003 | L* | a* | b* |
| No. | used | % | in plaque | (PPM) | (65) | (D65) | (D65) |
| 13 | V (solid) | 1.4 | 0.168 | 17.2 | 87.61 | 0.52 | 5.89 |
| 14 | VI (liquid) | 0.49 | 0.16 | 1.47 | 89.51 | 1.00 | 4.55 |
| Control | — | — | 0 | 77.5 | | | |

The control refers to CoPolymer POM with no additives.

The use of a solid masterbatch (Example 13) failed to achieve the target value of 2 ppm for automotive applications. The liquid formulation (Example 14) provided the required formaldehyde reduction coupled with reduced discoloration with a significantly reduced addition level. No discernible differences in emission profile or oxidation induction time were noted between formulation options.

### EXAMPLE 15—PREPARATION OF SOLID AND LIQUID FORMULATIONS COMPRISING COMPOUND X

Following the procedures described in Examples 5 and 6, solid and liquid formulations comprising Compound X were prepared having the compositions detailed in the table below.

In the following, the aldehyde scavenger (AS) component was Compound X, the anti-oxidant was Irganox 1010, the liquid carrier for Formulation No. VIII was Carrier A and the solid carrier for Formulation No. VII was Co-polymer POM.

| | Amount of | | |
|---|---|---|---|
| | AS | anti- | |
| Formulation | Component | oxidant | Carrier |
| No. | (wt %) | (wt %) | (wt %) |
| VII | 8 | 1.33 | 90.67 |
| VIII | 20 | 3.33 | 76.67 |

### EXAMPLE 16 TO 17—ASSESSMENT OF SOLID AND LIQUID FORMULATIONS COMPRISING COMPOUND X

Solid and liquid formulations VII and VIII were added to Ultraform S2320 POM co-polymer and plaques produced by injection moulding at the let-down-ratios (LDRs) as described in the table below. The formaldehyde emissions were assessed as described in Assessment 1 and the L*, a* (D65), b* (D65) were assessed as described in Assessment 2.

| | | | wt % | Formaldehyde | | | |
|---|---|---|---|---|---|---|---|
| | | | Compound | emissions | | | |
| Example | Formulation | LDR | X in | ISO: 16003 | L* | a* | b* |
| No. | used | % | plaque | (ppm) | (65) | (D65) | (D65) |
| 16 | VII (solid | 3.75 | 0.3 | 3.11 | 91.7 | 0.11 | 8.63 |
| | MB) | | | | | | |
| 17 | VIII (liquid) | 0.88 | 0.18 | 1.05 | 94.14 | 0.13 | 2.77 |
| Control | — | — | 0 | 77.5 | 95.63 | −0.44 | 0.24 |

The control refers to CoPolymer POM with no additives.

The use of a solid masterbatch failed to achieve the target value of 2 ppm for automotive applications (Example 16). The liquid formulation (Example 17) provided the required formaldehyde reduction coupled with reduced discoloration with a significantly reduced addition level. No discernible differences in emission profile or oxidation induction time between formulation options were observed.

### Example 18—Preparation of Solid and Liquid Formulations Comprising 2-Cyanoacetamide

Following the procedures described in Examples 5 and 6, solid and liquid formulations comprising cyanoacetamide were prepared having the compositions detailed in the table below. In the following, the aldehyde scavenger (AS) component was 2-cyanoacetamide, the anti-oxidant was Irganox 1010, the liquid carrier for Formulation No. X was Carrier A and the solid carrier for Formulation No. IX was Co-polymer POM.

| | Amount of | | | Amount of |
|---|---|---|---|---|
| | AS | anti- | | fumed |
| Formulation | Component | oxidant | Carrier | silica |
| No. | (wt %) | (wt %) | (wt %) | (wt %) |
| IX | 12 | 4 | 84 | 0 |
| X | 35 | 5.83 | 58.17 | 1 |

### EXAMPLES 19 AND 20—ASSESSMENT OF SOLID AND LIQUID FORMULATIONS COMPRISING 2-CYANOACETAMIDE

Solid and liquid formulations IX and X were added to Ultraform S2320 POM co-polymer and plaques produced by injection moulding at the let-down-ratios (LDRs) as described in the table below. The formaldehyde emissions were assessed as described in Assessment 1 and the L*, a* (D65), b* (D65) were assessed as described in Assessment 2.

| | | | | Formaldehyde | | | |
|---|---|---|---|---|---|---|---|
| | | | wt % | emissions | | | |
| Example | Formulation | LDR | cyanoacetamide | ISO: 16003 | L* | a* | b* |
| No. | used | % | in plaque | (ppm) | (65) | (D65) | (D65) |
| 19 | IX (solid MB) | 1.56 | 0.19 | 2.60 | 94.52 | −5.44 | 18.82 |
| 20 | X (liquid) | 0.27 | 0.09 | 1.57 | 95.23 | −2.79 | 7.41 |
| Control | — | — | 0 | 77.5 | 95.63 | −0.44 | 0.24 |

The control refers to CoPolymer POM with no additives.

The use of a solid masterbatch failed to achieve the target value of 2 ppm for automotive applications (Example 19). The liquid formulation (Example 20) provided the required formaldehyde reduction coupled with reduced discoloration with a significantly reduced addition level. No discernible differences in emission profile or oxidation induction time between formulation options were observed.

### EXAMPLES 21 TO 24—USE OF ANTHRANILAMIDE AS ALDEHYDE SCAVENGER AND SYNERGISTIC IMPACT OF FORMULATION COMPONENTS ON FORMALDEHYDE EMISSIONS

Following the procedure generally described for examples 8 to 11, individual components or mixtures of components included in the liquid formulations described were dosed into copolymer POM at the levels indicated and then assessed to determine the individual and/or collective effect on formaldehyde emissions and optical properties. Details of components and mixtures assessed and results are provided in the table below.

Where a carrier and an anti-oxidant were used, the components were Carrier A and Irganox 1010 respectively.

| | | Formaldehyde | | | |
|---|---|---|---|---|---|
| | Additives (and amount(s) | emissions | | | |
| | introduced into co-polymer | ISO:16003 | | | |
| Example No. | POM) | (ppm) | L | a* | b* |
| 21a | Carrier A (1.2 wt %) | 47.24 | 95.16 | −0.5 | 0.51 |
| (Comparison) | | | | | |
| 21b | Anti-oxidant (0.05 wt %) | 59.88 | 95.64 | −0.48 | 0.50 |
| (Comparison) | | | | | |
| 22 | Anthranilamide (0.3 wt %) + | 1.5 | 95.10 | 0.14 | 0.41 |
| | Carrier A (1.2 wt %) | | | | |
| 23 | Anthranilamide (0.3 wt %) + | 3.1 | 95.45 | 0.00 | −0.05 |
| | Anti-oxidant (0.05 wt %) | | | | |
| 24 | Anthranilamide (0.3 wt %) + | 0.1 | 95.39 | 0.11 | −0.13 |
| | Anti-oxidant (0.05 wt %) + | | | | |
| | Carrier A (1.2 wt %) | | | | |

The results show, in Example 22, that the combination of aldehyde scavenger and liquid also provide very low formaldehyde emissions; and, when scavenger, liquid and anti-oxidant are combined (Example 23), formaldehyde emissions are even lower.

### EXAMPLES 25 TO 27—USE OF COMPOUND X AS ALDEHYDE SCAVENGER AND SYNERGISTIC IMPACT OF FORMULATION COMPONENTS ON FORMALDEHYDE EMISSIONS

Following the procedure generally described for examples 8 to 11, individual components or mixtures of components included in the liquid formulations described were dosed into copolymer POM at the levels indicated and then assessed to determine the individual and/or collective effect on formaldehyde emissions and optical properties. Details of components and mixtures assessed and results are provided in the table below.

Where a carrier and an anti-oxidant were used, the components were Carrier A and Irganox 1010 respectively.

| | | Formaldehyde | | | |
|---|---|---|---|---|---|
| | | emissions | | | |
| Example | Additives (and amount(s) | ISO:16003 | | | |
| No. | introduced into co-polymer POM) | (ppm) | L* | a* | b* |
| 21a | Carrier A (1.2 wt %) | 47.24 | 95.16 | −0.5 | 0.51 |
| (comparison) | | | | | |
| 21b | Anti-oxidant (0.05 wt %) | 59.98 | 95.64 | −0.48 | 0.5 |
| (comparison) | | | | | |
| 25 | Compound X (0.39%) + | 0.13 | 88.61 | 2.56 | 8.62 |
| | Carrier A (1.2 wt %) | | | | |
| 26 | Compound X (0.39 wt %) + | 0.33 | 90.37 | 1.82 | 6.98 |
| | Anti-oxidant (0.05 wt %) | | | | |
| 27 | Compound X (0.39 wt %) + | <0.10 | 88.77 | 2.53 | 8.45 |
| | Anti-oxidant (0.05 wt %) + | | | | |
| | Carrier A (1.2 wt %) | | | | |

The results show, in Example 25, that the combination of aldehyde scavenger and liquid provide low formaldehyde emissions; and, when scavenger, liquid and anti-oxidant are combined (Example 27), formaldehyde emissions are even lower.

### EXAMPLE 28 TO 31—USE OF COMPOUND Y AS ALDEHYDE SCAVENGER AND SYNERGISTIC IMPACT OF FORMULATION COMPONENTS ON FORMALDEHYDE EMISSIONS

Following the procedure generally described for examples 8 to 11, individual components or mixtures of components included in the liquid formulations described were dosed into copolymer POM at the levels indicated and then assessed to determine the individual and/or collective effect on formaldehyde emissions and optical properties. Details of components and mixtures assessed and results are provided in the table below.

Where a carrier and an anti-oxidant were used, the components were Carrier A and Irganox 1010 respectively.

| | | Formaldehyde | | | |
|---|---|---|---|---|---|
| | | emissions | | | |
| Example | Additives (and amount(s) | ISO:16003 | | | |
| No. | introduced into co-polymer POM) | (ppm) | L* | a* | b* |
| 28 | Compound Y (0.3 wt %) | 2.31 | 94.99 | 0.12 | 0.14 |
| 29 | Compound Y (0.39%) + Carrier A | 0.58 | 95.42 | −0.16 | 0.04 |
| | (1.2 wt %) | | | | |
| 30 | Compound Y (0.39 wt %) + Anti-oxidant | 0.69 | 93.95 | 0.11 | 1.25 |
| | (0.05 wt %) | | | | |
| 31 | Compound Y (0.39 wt %) + Anti-oxidant | <0.10 | 94.18 | 0 | 0.9 |
| | (0.05 wt %) + Carrier A (1.2 wt %) | | | | |

For POM formulations, a wide range of materials may be incorporated into the formulations, including stabilisers such as hindered amine light stabilizers (HALS); acid scavengers eg calcium stearate, hydrotalcite; lubricants: eg waxes; BaSO₄, TiO₂, carbon black, pigments, aromatic polyamide, silicon powder, polytetrafluoroethylene and UV stabilisers.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of decreasing aldehyde content in a polyoxymethylene (POM) polymer, the method comprising the step of contacting the POM polymer, or monomers, oligomers or pre-polymers involved in the preparation of said POM polymer, with a liquid formulation, wherein said liquid formulation comprises a liquid carrier and an aldehyde scavenger.

2. A method according to claim 1, wherein the method comprises the step of contacting POM polymer with said liquid formulation.

3. A method according to claim 1, wherein said POM is a homopolymer POM or a copolymer POM.

4. A method according to claim 2, wherein said liquid formulation is a liquid at STP.

5. A method according to claim 2, wherein said aldehyde scavenger is selected from the following classes of scavengers:
(i) scavengers AS2 which include at least two component molecular fragments, each component molecular fragment comprising at least two hydrogen substituted heteroatoms bonded to carbons of the respective component molecular fragment;
(ii) scavengers AS5 which comprise a compound (A) which includes a first fragment, a second fragment and a third fragment wherein:
said first fragment comprises a moiety: 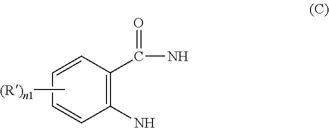
wherein R′ represents a substituent n1 is 0 to 4,
said second fragment comprises a moiety: 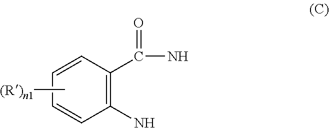
wherein R′ represents a substituent and n1 is 0 to 4 and
said third fragment comprises a moiety: 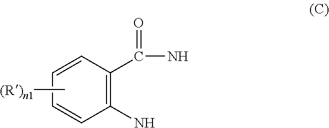
wherein R′ represents a substituent and n1 is 0 to 4;
(iii) scavengers AS7 which are of general formula 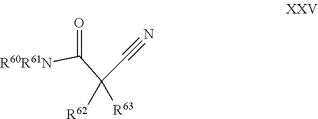
wherein R60 and R61 independently represent a hydrogen atom or an optionally-substituted, or an unsubstituted, alkyl, cycloalkyl or aromatic group; and
wherein R62 and R63 independently represent a hydrogen atom or an optionally-substituted, or an unsubstituted, alkyl, cycloalkyl or aromatic group.

6. A method according to claim 5, wherein said aldehyde scavenger is selected from the following:
anthranilamide, 1,8-diaminonaphalene, allantoin, 3,4-diaminobenzoic acid, malonamide, salicylanilide, 6-amino-1,3-dimethyluracil (DMU), 6-aminoisocytosine, 6-aminouracil, 6-amino-1-methyluracil;
a scavenger AS5 which includes a structure: 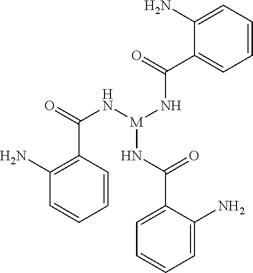
wherein M represents a Main Fragment which includes a saturated hydrocarbon moiety which optionally incorporates a nitrogen atom;
a scavenger AS7 of formula XXV, wherein R⁶⁰ and R⁶¹ independently represent a hydrogen atom or an unsubstituted alkyl or cycloalkyl group and R⁶² and R⁶³ independently represent a hydrogen atom or an unsubstituted alkyl or cycloalkyl group.

7. A method according to claim 1, wherein said aldehyde scavenger is selected from anthranilamide, cyanoacetamide or a compound XX which is

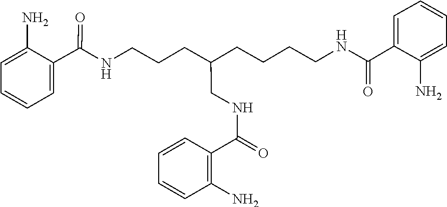 [SMILES: Nc1ccccc1C(=O)NCCCCC(CCCNC(=O)c1ccccc1N)CNC(=O)c1ccccc1N]

8. A method according to claim 1, wherein said aldehyde scavenger includes a moiety 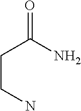
wherein the carbon atoms are part of a phenyl ring; or includes a moiety

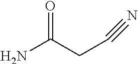

9. A method according to claim 1, wherein said formulation includes at least 30 wt % liquid carrier.

10. A method according to claim 1, wherein said liquid formulation comprises 50 to 90 wt % liquid carrier and 10 to 50 wt % aldehyde scavenger.

11. A method according to claim 10, wherein said liquid carrier is an oil or a glycol.

12. A method according to claim 28, wherein said formulation includes 0.5 to 10 wt % of an anti-oxidant.

13. A method according to claim 12, wherein said anti-oxidant comprises a sterically-hindered phenol compound.

14. A method according to claim 13, wherein said anti-oxidant is of formula 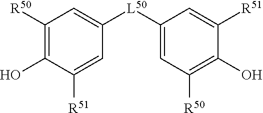
wherein L⁵⁰ is a linking moiety which includes an oxyalkylene moiety and one or more ester moieties.

15. A method according to claim 5, wherein said method decreases aldehyde content in the POM polymer so the POM polymer includes 2 ppm or less of aldehyde when assessed according to VDA-275.

16. A polyoxymethylene (POM) polymer, having a reduced level of aldehyde, said POM polymer incorporating an aldehyde scavenger according to claim 5 or a product of a reaction between an aldehyde scavenger according to claim 5 and aldehyde.

17. A polymer according to claim 16, wherein said POM polymer includes 2 ppm or less of aldehyde when assessed according to VDA-275; said POM polymer including a residual carrier; and/or said POM polymer including an anti-oxidant; and/or said POM polymer is in pellet form.

18. (canceled)

19. (canceled)

20. (canceled)

21. A method of making an article or pellets from a polyoxymethylene (POM) polymer, the method comprising:
(a) selecting a liquid formulation comprising a liquid carrier and an aldehyde scavenger as described in claim 28;
(b) contacting the POM polymer with said liquid formulation; and
(c) forming said POM polymer into an article, or into pellets.

22. A method according to claim 21, wherein said article or pellets include 2 ppm or less of aldehyde when assessed according to VDA-275; and/or in step (c), the POM polymer is melt-processed to define said article or pellets; and/or said article or pellets include one or more colourants; and/or wherein, in said article, the sum of the wt % of one or more POM polymer(s) and the aldehyde scavenger is at least 90 wt %.

23. (canceled)

24. (canceled)

25. (canceled)

26. (canceled)

27. (canceled)

28. A method according to claim 5, wherein said liquid formulation comprises 50 to 90 wt % liquid carrier and 10 to 50 wt % aldehyde scavenger.
